(19) United States
(12) Patent Application Publication
(10) Pub. No.: US 2015/0180972 A1
(43) Pub. Date: Jun. 25, 2015

(54) Method for Transferring Data from a Field Device to a Web Browser

(71) Applicant: Endress + Hauser Conducta Gesellschaft für Mess- und Regeltechnik mbH + Co. KG, Gerlingen (DE)

(72) Inventors: Dietrich Wentland, Stuttgart (DE); Gunter Jahl, Lochgau (DE); Holger Eberhard, Stuttgart (DE); Martin Lohmann, Gerlingen (DE)

(21) Appl. No.: 14/572,851

(22) Filed: Dec. 17, 2014

(30) Foreign Application Priority Data
Dec. 20, 2013 (DE) 10 2013 114 613.9

(51) Int. Cl. H04L 29/08; G06F 3/0483; G06F 3/0481; H04L 29/06

(52) U.S. Cl. CPC H04L 67/1095; H04L 67/02; H04L 69/16; G06F 3/0483; H04L 67/125; G06F 3/04817

(57) ABSTRACT

A method for transferring static data and dynamic data from a measuring point at least comprising a field device of process automation technology containing a Web server to a Web browser having tabbed navigation. The static data comprises at least an identification of the measuring point, characterized in that the identification of the measuring point is displayed in the title of a tab of the Web browser having tabbed navigation. Also contemplated is a field device for performing the method.

The invention relates to a method for transferring static data and dynamic data from a measuring point at least comprising a field device of process automation technology containing a Web server to a Web browser with tabbed navigation. The invention relates further to a field device for performing such method.

In process automation technology, especially for automation of chemical processes or procedures for producing a product from a raw or starting material by use of chemical, physical or biological processes and/or for control of industrial plants, measuring devices installed near to the process, so-called field devices, are applied. Field devices embodied as sensors can monitor, for example, process measurement variables, such as pressure, temperature, flow, fill level, or measured variables of liquid and/or gas analysis, such as, for example, pH-value, conductivity, concentrations of certain ions, chemical compounds and/or concentrations or partial pressures of gases.

In a process installation, frequently a large number of the most varied of sensors are used. A sensor arranged at a certain location of installation in the process, for example, a sensor embodied for registering one or more measured variables and installed at a certain location, forms together with a measurement transmitter a measuring point. A measuring point can also utilize a number of sensors and/or measurement transmitters, so that a measuring point is not necessarily limited to a single process parameter or to a single measurement signal.

A sensor includes, as a rule, a measuring transducer, which is embodied to register the measured variable to be monitored and to produce an electrical measurement signal correlated with the current value of the measured variable. Serving for additional processing of the measurement signal is an electronic circuit, which is embodied further to process the electrical measurement signal, for example, to digitize it, into a measured value of the measured variable and/or to convert it into a variable derived from the measured value, and, in given cases, to output such to a superordinated unit. The circuit can provide, besides the measured value formation and measured value forwarding, more extensive functions. For example, it can be embodied to perform a more extensive evaluation of the measured values or to execute a sensor diagnostics, based on which a current state of the sensor is determined and/or a prediction of the remaining life of the sensor made. The circuit can be arranged completely or partially in a transmitter.

As already mentioned, a measuring point is formed of one or more sensors and/or transmitters and, in general, of at least one field device of process automation. For identification of the measuring point, such is provided with a measuring point identification, also called a device tag. This is up to 32 characters or bits long and is recognized and processed by fieldbus protocols, such as e.g. the HART, Profibus and Fieldbus Foundation protocols. Especially, there is for HART devices also a shorter form with only 8 characters or bits.

Furthermore, the identification can be read from the field device and, in given cases, edited. Device tags serve for identifying the field devices in a plant. They are defined by the user and stored in the devices. Additionally, the device tag is frequently presented on a, most often, metal tag plate, on the device or at the site of installation of the device.

Besides the mentioned fieldbus protocols, increasingly also Ethernet protocols and Web servers are implemented in field devices, in order that a device can be serviced by means of a Web browser.

In the case of Web browsers, the field device is accessed via an IP address, which is displayed in the address bar. Displayed in the browser window are data, which the Web server of the field device delivers. This data can be, for example, the measuring point designation, measurement data, parameters, etc. If there are opened in the browser a number of windows for connections to different devices, the windows are distinguished only by their address bar and the therein presented IP address. This IP address can dynamically change and has no relationship with the measuring point designation. The correct associating of a browser window and the presented data with the relevant device, is, thus, a difficult task.

An object of the invention is to simplify for the operator the associating of the transferred data with the relevant field device.

The invention is achieved by a method for transferring static data and dynamic data from a measuring point at least comprising a field device of process automation technology containing a Web server to a Web browser with tabbed navigation, wherein the static data comprises at least an identification of the measuring point. The method is characterized in that the identification of the field device, especially the device tag, is displayed in the title of a tab of the Web browser with tabbed navigation.

It can, thus, be immediately recognized, which measuring point is displayed in which tab.

Web browsers are computer programs for representing Web pages. Most of the user interface of a modern Web browser is, as a rule, utilized for display of contents. This can be achieved by inputting an address in an address bar. Along with that, browsers make use of buttons, with which a user can navigate to earlier visited pages as well as to the start page. Newer browsers most often support tabbed browsing, which enables opening a number of pages in different tabs. In tabbed browsing, individual documents are indicated within the shared program window, in each case, via a button on the edge of the display. These buttons are analogous to index card tabs or file tabs. Pages located in the background can be selected upon tabbed browsing via the tabs analogous to the tabs of index cards, wherein the tabs are arranged in their own tab bar in the browser display. In such case, each document no longer has its own application, but, instead, all documents, i.e. pages, are indicated by tabs of one application and are selectable via the tabs arranged in a tab bar.

Browsers are mainly applied in PCs. Examples of well-known browsers include Internet Explorer, Firefox, Opera, Safari and Chrome. However, also mobile end devices (PDAs, smartphones etc.) make use of browser software for accessing the World Wide Web. Modern mobile browsers include, for example, Opera mini, Internet Explorer, Firefox mobile, Dolphin browser, Boat browser, Google Chrome, Safari, Android browser and Skyfire.

In an advantageous embodiment, the dynamic data is at least a device state, and the device state is displayed in the tab, especially in the form of a status signal. The status signal represents the device state according to NAMUR recommendation NE107. Thus, besides the identification of the measuring point, also its state can immediately be seen. Especially this is the case when the particular tab is not newly loaded.

Preferably, the device state is displayed as a favicon. This is a convenient method for immediately showing a state. Especially, the symbols defined in NE107 are used as favicons for the status signal.

In a preferred form of embodiment, the device state is given as one of the states, failed, check function, out of specification or maintenance required.

In an advantageous embodiment, the dynamic data is the identification of the measuring point. While the measuring point designation is, as a rule, not very frequently changed, nevertheless methods, which are reserved for dynamic data, can be applied, in order to transfer dynamic data, thus, for instance, the measuring point identification.

For resource conserving transfer, static data and dynamic data are transferred asynchronously.

Preferably, an Ajax application is used for asynchronous transfer.

In an advantageous embodiment, the static data and dynamic data are transferred per JavaScript.

Preferably used as markup language is HTML5.

For instantaneous transfer, at least the dynamic data is transferred as “server push”, especially dynamic data is sent upon a change.

For security, preferably static and dynamic data is transferred encrypted.

The object is further achieved by a field device of process automation technology for performing a method as above described.

Preferably, the field device includes a data processing unit, especially a transmitter, and/or a sensor.

The invention will now be explained in greater detail based on the appended drawing, the figures of which show as follows:

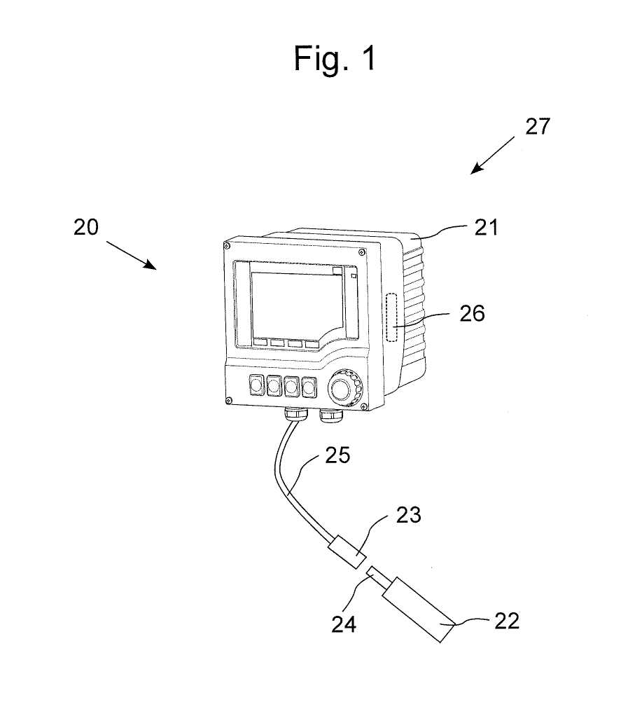

FIG. 1 a field device of the invention, and

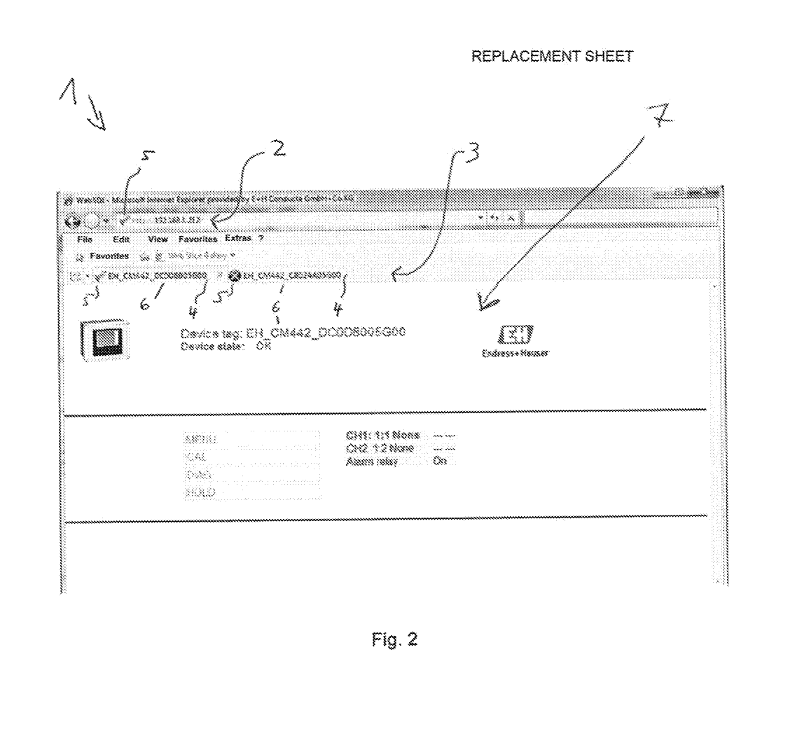

FIG. 2 a view of a Web browser with tabbed navigation, for illustrating the method of the invention.

In the figures, equal features are provided with equal reference characters.

The field device of the invention in its totality bears the reference character 20 and is shown in FIG. 1.

Field device 20 includes a data processing unit 21 and/or a sensor 22 and forms a measuring point 27. Via a first interface 24, the sensor 22 communicates, in general as a consumer, with a data processing unit 21, for instance, a transmitter (also called a measurement transmitter). Provided from the transmitter 21 is a cable 25, on whose other end there is a second interface 23 complementary to the first interface 24. The interfaces 23, 24 are embodied as galvanically isolated, especially inductive, interfaces, which can be coupled with one another by means of a mechanically plugged connection. Sent via the interfaces 23, 24 are data (bidirectional) and energy (unidirectional, i.e. from the transmitter 21 to the sensor 22). The transfer of data occurs in digital form. Transmitter 21 is embodied as a two, or four, conductor device. The applicant sells such products, for example, under the marks “Endress+Hauser Liquiline M CM42” and “Endress+Hauser Liquiline M CM442”.

Field device 20 is predominantly applied in process automation. Sensor 22 is, therefore, for instance, a pH-, redox-potential-, also ISFET-, temperature-, conductivity-, pressure-, oxygen-, especially dissolved oxygen-, or carbon dioxide sensor; an ion-selective sensor; an optical sensor, especially a turbidity sensor, a sensor for optically determining the oxygen concentration, or a sensor for determining number of cells and cell structures; a sensor for monitoring certain organic or metal compounds; a sensor for determining concentration of a chemical substance, for example, of a certain element or a certain compound; or a biosensor, e.g. a glucose sensor. Other options for use include application in pressure-, fill level-, flow- or temperature measuring points.

As already mentioned, a sensor 21 arranged at a certain location of installation in the process, for example, a sensor 21 installed at a certain location and embodied for registering one or more measured variables, forms, together with a measurement transmitter 20, a measuring point 27. A measuring point 27 can also include a number of sensors 20 and/or measurement transmitters 21, so that a measuring point 27 is not necessarily limited to a single process parameter or a single measurement signal. For identification of the measuring point 27, it is provided with a measuring point identification, also called a device tag. This is up to 32 characters or bits long and is recognized and processed by fieldbus protocols such as e.g. HART, Profibus or Fieldbus Foundation. Furthermore, the measuring point identification can be read from the field device and, in given cases, edited. The device tag serves for identifying a field device in a plant. It is defined by the user and is stored in the device. Additionally, the device tag is frequently provided as a, most often metal, label, which is placed on the device or at the site of installation of the device.

Field device 20 includes a Web server 26. A Web server is a server, which transmits documents to clients, such as e.g. a Web browser 21 (see below). Web server 26 can be connected locally, in company networks and with the World Wide Web service in the Internet. Data can, thus, be made available for various purposes locally, company internally and even worldwide.

The task of the Web server 26 is to deliver static files, e.g. unchanging HTML- or picture files, or dynamic files. Static data in the sense of this invention includes identification of the measuring point 27, also called the device tag. Additionally, especially in fieldbus systems, the fieldbus address can be used. Other static data for a field device include the serial number or the product, respectively family, name. Dynamic data in the sense of this invention include the device state. According to NAMUR recommendation NE107, the device state includes, especially, the states, failed (F=failed), check function (C=check function), out of specification (S=out of specification) or maintenance required (M=maintenance required). Thus, the initials F, C, S and M are also referred to as status signal. Other possible states of the field device 20 include, for instance, alarm, warning, offline, hold, etc. Measured values are an example of other dynamic data. Also, only a certain measured value can be displayed, for instance, the maximum or minimum value, an average value, the last measured value, the measured value at a certain clock time, etc.

Additionally, dynamic data can include the identification of the measuring point. While the measuring point identification is, as a rule, not very frequently changed, nevertheless methods, which are reserved for dynamic data, can be applied, in order to transfer dynamic data, thus, for instance, the measuring point identification. A possible method involves, in such case, JavaScript in conjunction with an Ajax application (see below).

Transmitted for a complete Web page are, as a rule, the HTML page, including linked design descriptions (CSS) and picture files (JPG, PNG, GIF, Flash), in each case, as individual files. For each required file, the Web browser must transmit its own query to the Web server, i.e., for representing a complex Web page, sometimes hundreds of queries and server responses are necessary.

Alternatively to this, an Ajax application (Asynchronous JAvaScript and XML) can be used. Ajax refers to a concept of asynchronous data transfer between a Web browser 1 and the Web server 26. This enables HTTP queries, while an HTML page is being displayed, and changing the page, without having to completely reload it. In such case, for instance, JavaScript can serve for manipulating the Document Object Model (thus the specification of an interface for accessing HTML or XML documents) and for dynamically representing the contents. JavaScript can also be applied as an interface between individual components. Ajax applications, in contrast, are able to send to the server queries, in which only that data is requested, which is actually required. This happens by invoking a Web service, e.g. via REST, SOAP. The invoking occurs in the form of asynchronous communication, i.e., while the data is being loaded from the server, the user can interact further with the interface. If the data has been loaded and is ready, then an above-mentioned JavaScript function is invoked, which can incorporate the data into the Web page.

As a result, one obtains a user interface, which reacts very rapidly to user input. A reason for this changed behavior is the fact that significantly less data needs to be exchanged between Web browser 1 and Web server 26, and that the loading of the data occurs asynchronously. Additionally, the Web server load is reduced, since already many processing steps can be performed client side.

Used as markup language can be especially HTML5, whereby a faster change of the favicon can be achieved. Also, JavaScript can use HTML5.

Serving as transfer methods can be standardized transfer protocols (HTTP, HTTPS (syntactically, HTTPS is identical with the schema for HTTP, wherein the additional encryption of the data occurs by means of SSL/TLS)), and network protocols such as IP and TCP, usually via port 80 (HTTP) and port 443 (HTTPS). HTTP is the most often applied protocol.

Other network protocols such as SPDY provided other options. An advantage of SPDY is that then the Web server 26 can initiate transfers and transfer contents directly and without query to the Web browser 21 (“server push”). Thus, updated contents (e.g. the device state) can be sent directly to the already loaded page, which then updates the corresponding regions, without reloading by the user or continuous retrieval using scripts. Associated therewith, among other things, the loading times of further page calls can be lessened and a better loading of the network achieved, since senseless queries based on hunches are omitted.

In process automation, the EtherNet/IP has established itself for network access (the physical layer (OSI Layer 1) as well as also the data link layer (OSI Layer 2)). EtherNet/IP is real time Ethernet, also referred to as industrial Ethernet. However, also suited is EtherNet/IP not for “hard” real time applications (<1 ms). The typical cycle time of an EtherNet/IP network lies at 10 ms and satisfies, thus, software real-time requirements for industrial inputs/outputs. Alternatives for hard real-time requirements include CIPSync, respectively MotionSync, which represent protocol expansion for EtherNet/IP. Other real-time capable Ethernet protocols are: Profinet, Ethernet Powerlink, SERCOS III, EtherCAT, VARAN and SafetyNET p.

FIG. 2 shows a screen shot of a browser 1. To be seen in the browser 1 is a browser page 7, here a Web page, which was sent from the Web server 26 of the field device 20. More exactly, the field device 20 has been accessed in the Web browser 1 via an IP address, which is displayed in the address bar 2. As already mentioned, the IP address can change dynamically and has no relationship to the measuring point identification.

Displayed in the browser window 7 are the data, which the Web server delivered from the field device, especially thus, static data and dynamic data.

To be seen in the browser window 7 is, for instance, the identification 6 of the measuring point 27. As already mentioned, the identification is also referred to as the device tag.

Browser 1 supports tabbed browsing, i.e. displayed in the browser 1 are data in tabs 4, which are arranged in a tab bar 3. For example, each connection to another field device can be displayed in another tab 4; upon connections to a number of field devices, thus, an equivalent number of tabs 4 are opened. These tabs 4 can receive unique names, which are provided by the Web server 26, thus by the field device 20. For simple associating of the tab 4 with the field device 20, the tab 4 can receive the identification 6 of the measuring point 27 as its name. Especially, this name is displayed in the title of the tab 4. Thus, in the case of a number of opened tabs, each title makes the relevant measuring point 27 and therewith the relevant field device 20 immediately recognizable. In this way, possible mixups are prevented. Measured values of different measuring points 27 are not wrongly associated. Configurations, which were intended for a particular measuring point 27, are not performed on some other measuring point.

Displayed in the browser 1 are, moreover, dynamic data, such as the device state. For example, the above mentioned status signal F, C, S or M is displayed in the browser 1. However, also other possible states of the field device 20, such as, for instance, alarm, warning, offline or hold, can be displayed.

The device state is displayed in the browser 1 as favicon 5. Favicon 5 is displayed, in such case, on the left of the address bar 2 or on the left of the title of the tab 4. The user sees, thus, immediately, the instantaneous state of the field device, even when the tab 4 is not active. In FIG. 2, this is accomplished by the symbols marked with the reference characters 5. Other symbols provide, however, other options, especially symbols, which directly indicate the status signal F, C, S or M.

In the case of a change, the new state of the field device 20 can be transferred instantaneously to the Web browser 1 (“server push”), or via an Ajax application (for instance, by JavaScript, see above), or only upon updating of the Web page.

The static and/or dynamic data can be transferred encrypted, such as was already mentioned, for instance, via the communication protocol HTTPS.

There is the opportunity to transmit the static and/or dynamic data compressed (e.g. gzip and others). The majority of modern browsers support this HTTP compression.

### LIST OF REFERENCE CHARACTERS

1 browser window
2 address bar
3 tab bar
4 tab
5 favicon
6 identification
7 browser window
20 field device
21 data processing unit
22 sensor
23 interface
24 interface
25 cable
26 Web server
27 measuring point

1-13. (canceled)

14. A method for transferring static data and dynamic data from a measuring point at least comprising a field device of process automation technology containing a Web server to a Web browser, comprising the steps of:
providing tabbed navigation, wherein the static data comprises at least an identification of the measuring point; and
displaying the identification of the measuring point in the title of a tab of the Web browser having said tabbed navigation.

15. The method as claimed in claim 14, wherein:
the dynamic data is at least a device state, and the device state is displayed in the tab, especially as a status signal.

16. The method as claimed in claim 15, wherein:
the device state is displayed as a favicon.

17. The method as claimed in claim 15, wherein:
the device state is given as one of the states, failed, check function, out of specification or maintenance required.

18. The method as claimed in claim 14, wherein:
the dynamic data is the identification of the measuring point.

19. The method as claimed in claim 14, wherein:
static data and dynamic data are transferred asynchronously.

20. The method as claimed in claim 19, wherein:
an Ajax application is used for asynchronous transfer.

21. The method as claimed in claim 14, wherein:
static data and dynamic data are transferred per JavaScript.

22. The method as claimed in claim 14, wherein:
HTML5 is used as markup language.

23. The method as claimed in claim 14, wherein:
at least the dynamic data is transferred as “server push”, especially dynamic data is sent upon a change.

24. The method as claimed in claim 14, wherein:
static and dynamic data is transferred encrypted.

25. A field device of process automation technology for performing a method comprising the steps of:
a method for transferring static data and dynamic data from a measuring point at least comprising a field device of process automation technology containing a Web server to a Web browser, comprising the steps of: providing tabbed navigation, wherein the static data comprises at least an identification of the measuring point; and displaying the identification of the measuring point in the title of a tab of the Web browser having said tabbed navigation.

26. The field device as claimed in claim 26, wherein:
the field device includes a data processing unit, especially a transmitter, and/or a sensor.
